(19) United States
(12) Patent Application Publication
(10) Pub. No.: US 2025/0122593 A1
(43) Pub. Date: Apr. 17, 2025

(54) RECOVERY OF POTASSIUM AND AMMONIA SALTS BY INDUCED PRECIPITATION WITH CO2

(71) Applicant: Nuovo Pignone Tecnologie – S.r.l., Florence (IT)

(72) Inventors: Stylianos Pachitsas, Florence (IT); Jose Adrian Chavez Velasco, Ciudad Guzman (MX)

(21) Appl. No.: 18/487,439

(22) Filed: Oct. 16, 2023

(51) Int. Cl. C22B 3/44; C22B 26/10

(52) U.S. Cl. CPC C22B 3/44; C22B 26/10

(57) ABSTRACT

A process of recovering solid potassium/ammonia salts includes: introducing an aqueous stream containing at least one of ammonium cations or potassium cations, and at least one of carbonate anions or bicarbonate anions into a treatment unit; introducing a carbon dioxide stream containing CO₂ into the treatment unit; contacting the aqueous stream with the carbon dioxide stream to form a mixture; removing heat from the treatment unit to control a temperature of the mixture; forming a slurry from the mixture, the slurry including water and at least one of a solid potassium salt, or a solid ammonium salt; withdrawing the slurry from the treatment unit as a treated aqueous stream; and introducing the treated aqueous stream into a separator to generate a brine stream, and a recovered potassium and/or ammonia salt stream containing at least one of the solid potassium salt or the solid ammonium salt.

### BACKGROUND

Carbon dioxide is a primary driver of global climate change; therefore, it is critical to reduce its emissions. A mixed salt process (MSP) uses aqueous mixtures of potassium carbonate and ammonium salts as solvents and is a promising technology for capturing CO₂. Nevertheless, some available process configurations under certain operating conditions require a considerable makeup of potassium carbonate and ammonia due to stream purges needed to maintain mass balance in a continuous operation. Unfortunately, this increases the cost of process operation related to consumption of chemicals and liquid waste treatment. Furthermore, there is a continuing need for an energy efficient MSP process for CO₂ capture.

### SUMMARY

A process of recovering potassium and/or ammonia salts includes: introducing an aqueous stream containing at least one of ammonium cations or potassium cations, and at least one of carbonate anions or bicarbonate anions into a treatment unit; introducing a carbon dioxide stream containing CO₂ into the treatment unit; contacting the aqueous stream with the carbon dioxide stream to form a mixture; removing heat from the treatment unit to control the temperature of the mixture; forming a slurry from the mixture, the slurry including water and at least one of a solid potassium salt, or a solid ammonium salt; withdrawing the slurry from the treatment unit as a treated aqueous stream; and introducing the treated aqueous stream into a separator to generate a brine stream, and a recovered potassium and/or ammonia salt stream containing at least one of the solid potassium salt or the solid ammonium salt.

An absorber as used herein can include one absorber unit or several interconnected absorber units. Each absorber unit can independently generate a CO₂-containing solution. A process of capturing CO₂ includes: contacting a CO₂-rich gas with an aqueous absorption solution in an absorber including one absorber unit or a system of interconnected absorber units to generate one or more CO₂-containing solutions and a CO₂-depleted gas stream; providing one or more CO₂-depleted aqueous solutions from a regenerator; transferring heat from the one or more CO₂-depleted aqueous solutions to the one or more CO₂-containing solutions; introducing the one or more CO₂-containing solutions after heat exchange to the regenerator, the regenerator producing a CO₂ gas stream and the one or more CO₂-depleted aqueous solutions; introducing about 0.1 to about 3 vol % of any of the one or more CO₂-depleted aqueous solutions after heat exchange into a treatment unit as a set of aqueous streams; introducing about 0.1 to about 5 vol % of the CO₂ gas stream generated from the regenerator as a carbon dioxide stream into the treatment unit; and recovering solid potassium and/or ammonia salts in accordance with the process as described herein above.

### BRIEF DESCRIPTION OF THE DRAWINGS

The following descriptions should not be considered limiting in any way. With reference to the accompanying drawings, like elements are numbered alike:

FIG. 1 is a simplified scheme illustrating an embodiment of a process to recover solid potassium and/or ammonia salts from an aqueous stream that contains at least one of K⁺ or NH₄⁺, and at least one of CO₃²⁻ or HCO₃⁻¹;

FIG. 2 is a simplified scheme illustrating an embodiment of a process to recover solid potassium and/or ammonia salts from an aqueous stream purged from a regenerator using a fraction of carbon dioxide stream produced from the regenerator; and

FIG. 3 is a simplified scheme illustrating an embodiment of a process to recover solid potassium and/or ammonia salts in the context of a potential MSP layout to capture CO₂.

### DETAILED DESCRIPTION

The inventors hereof have discovered an efficient process for recovering potassium and/or ammonia salts from a purged aqueous stream from a mixed salt process by inducing the precipitation of the salts with CO₂ and temperature control.

The process has low complexity in terms of equipment set up. Key agent CO₂ for inducing the recovery of potassium and/or ammonia salts is readily available at the MSP plant as product. As compared to a conventional evaporation/vacuum crystallization process, the process as described herein has the added advantage of also recovering ammonia-based salts. The process can be more energy efficient as compared to a conventional evaporation/vacuum crystallization process.

The recovered salts from the process can be recycled for further CO₂ capture in the MSP plant or being sold as valuable products to external markets. The cost for recovering potassium and/or ammonium salts through the disclosed process can be lower as compared to the price of commercial potassium and ammonium salts feedstocks available on the market.

The process provides a reliable solution for recovering potassium and/or ammonia salts and helps to reduce waste from MSP as well as makeup of solvents, potassium carbonate and ammonia, thus shifting the operating envelope of MSP to less energy costly operating conditions, and improving overall plant economics and sustainability.

A detailed description of one or more embodiments of the disclosed process are presented herein by way of exemplification and not limitation with reference to the Figures.

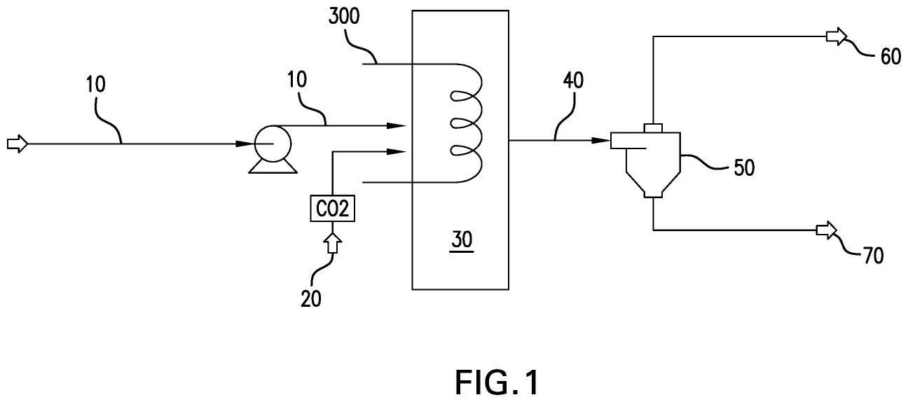

Referring to FIG. 1, a process of recovering potassium and/or ammonia salts comprises introducing an aqueous stream (10) containing dissolved potassium and/or ammonia salts into a treatment unit (30); introducing a carbon dioxide stream (20) into the treatment unit (30); contacting or mixing the aqueous stream (10) with the carbon dioxide stream (20) in the treatment unit (30) to generate a mixture; removing heat from the treatment unit (30) to control a temperature of the mixture; forming a slurry from the mixture, the slurry comprising water and at least one of a solid potassium salt, or a solid ammonium salt; and introducing the slurry into a separator (50) as a treated aqueous stream (40) to generate a recovered potassium and/or ammonia salt stream (70) and a brine stream (60). Advantageously, the process is a continuous process.

The aqueous stream (10) comprises dissolved potassium and/or ammonia salts, for example, the aqueous stream (10) comprises at least one of potassium cations or ammonium cations, and at least one of carbonate anions or bicarbonate anions. In an aspect, the aqueous stream (10) comprises both potassium cations and ammonium cations, and one or both of carbonate anions or bicarbonate anions. The aqueous stream (10) can also comprise at least one of dissolved ammonia, carbamate anions, or hydroxide anions.

A content of the potassium cations in the aqueous stream (10) can be about 0.1 to about 10 molal or about 1 to about 10 molal (mole per kilogram of solvent, m). A content of ammonia (NH₃ and ammonia containing ions) can be about 0.05 to about 10 molal, about 0.1 to about 8 molal, or about 0.1 to about 6 molal. A content of water in the aqueous stream (10) can be about 55 to about 95 wt % or about 80 to about 90 wt %, based on a total weight of the aqueous stream.

In the aqueous stream, the cations and anions are dissociated with each other. In an aspect, the aqueous stream (10) contains less than about 20 wt % of solids, less than about 15 wt % of solids, less than about 10 w % of solids, less than about 5 wt % of solids, less than about 0.5 wt % of solids, or less than 0.1 wt % of solids, each based on the total weight of the aqueous stream. The aqueous stream can be free of solids.

The aqueous stream (10) can have a temperature of about 25 to about 60° C., preferably about 25 to about 50° C., or about 25 to about 45° C. The aqueous stream can have a pressure above 1 bar, for example a pressure of about 1.5 to about 35 bars.

The carbon dioxide stream (20) can comprise greater than about 80 vol %, greater than about 85 vol %, or greater than about 95 vol % of CO₂ based on the total volume of the carbon dioxide stream.

The carbon dioxide stream (20) can have a temperature of about 5 to about 45° C., preferably about 5 to about 40° C., more preferably about 5 to about 35° C. The carbon dioxide stream (20) can have a pressure of about 1 to about 40 bars, about 5 to about 30 bars, or about 10 to about 20 bars.

The carbon dioxide stream (20) and the aqueous stream (10) can be separately introduced into the treatment unit (30). Alternatively, the carbon dioxide stream (20) and the aqueous stream (10) can be combined before being introduced into the treatment unit (30).

The treatment unit (30) can be a mixer which has a means to mix the aqueous stream (10) and the carbon dioxide stream (20) and control the temperature of the mixture to modify the solubility of salts and gas CO₂. The treatment unit (30) can also be a vertically oriented column. The aqueous stream (10) can be introduced at the upper section of the column, and the CO₂ stream (20) can be introduced at the lower section of the column to facilitate the dissolution of the carbon dioxide in the aqueous stream (10).

In the treatment unit (30), the aqueous stream (10) is contacted or mixed with CO₂. During contacting or mixing, at least a portion of the CO₂ from the carbon dioxide stream is dissolved in the aqueous stream. The aqueous stream can be saturated with CO₂ in the treatment unit.

The treatment unit (30) has a cooling means (300) to cool down the aqueous stream (10) when it contacts the carbon dioxide stream (20), thereby promoting the dissolution of CO₂ in the liquid phase, which in turn enhances the precipitation of solids. Alternatively or in addition, the cooling means (300) can remove the heat that may be generated during the reactions to form potassium and/or ammonia salts, thus further facilitating the formation and precipitation of solids. During the process, a temperature of the mixture of the aqueous stream (10) and the carbon dioxide stream (20) in the treatment unit (30) can be controlled to be about a freezing point of the mixture to about 30° C., or about 2 to about 30° C., or about 5 to about 25° C. As used herein, about a freezing point of the mixture means that the temperature can be about 0.5° C., about 1° C., or about 2° C. above the freezing point of the mixture.

The cooling means (300) is not particularly limited, and is known to a person skilled in the art. For example, the treatment unit (30) can have a jacket having circulating fluids that takes heat away from the treatment unit (30). The treatment unit (30) can be a cooling mixer in an aspect.

The pressure in the treatment unit can be atmospheric pressure or a pressure higher than the atmospheric pressure, for example, about 1 to about 40 bars or about 1 to about 30 bars. The pressure can be generated by the flow of liquids and gases.

By contacting the aqueous stream with the carbon dioxide stream, and optionally further by cooling the aqueous stream, a solid potassium salt, a solid ammonium salt, or a combination thereof can precipitate from the aqueous stream forming a slurry. The solid salts can be present in the form of particles. The slurry can have a temperature of about a freezing point of the slurry to about 30° C., about 2 to about 30° C., or about 5 to about 25° C.

Without wishing to be bound by theory, it is believed that CO₂ dissolves in water forming bicarbonate ions, carbonate ions, or a combination thereof according to equation (1) and equation (2).

CO₂(aq)+2H₂O(l)↔HCO₃⁻(aq)+H₃O⁺(aq) (1)

HCO₃(aq)+H₂O(l)↔CO₃²⁻(aq)+H₃O⁺(aq) (2)

The increased concentration of carbonate ions and/or bicarbonate ions shifts the equilibrium equations (3)-(6) to the left, forming a slurry comprising at least one of a solid potassium salt, or a solid ammonium salt.

K₂CO₃(solid)↔2K⁺(aq)+CO₃²⁻(aq) (3)

KHCO₃(solid)↔K⁺(aq)+HCO₃⁻(aq) (4)

(NH₄)₂CO₃(solid)↔2NH₄⁺(aq)+CO₃²⁻(aq) (5)

NH₄HCO₃(solid)↔NH₄⁺(aq)+HCO₃⁻(aq) (6)

In an aspect, the slurry comprises both a solid potassium salt and a solid ammonia salt. Examples of the solid potassium salts include potassium carbonate and potassium bicarbonate. Examples of the solid ammonia salts include ammonium carbonate and ammonium bicarbonate. The slurry can include more than one solid salts and/or hydrate forms thereof.

A solid content of the slurry can vary based on the aqueous stream to be treated and the temperature of the slurry. In an aspect, a solid content of the slurry is about 0.1 to about 45 wt %, about 0.1 to about 40 wt %, or about 0.1 to about 35 wt %, each based on a total weight of the slurry.

The generated slurry is withdrawn from the treatment unit (30) as a treated aqueous stream (40), and the treated aqueous stream (40) can be introduced into a separator (50), where solids are separated from the aqueous phase, generating a recovered potassium and/or ammonia salt stream (70), and a brine stream (60).

Any separator that is effective in separating solids from liquids can be used. Examples of the separator can include centrifugal separators, filters, gravity settlers, hydrocyclones, and screens. Other suitable solid/liquid separators known in the art can also be used. In an aspect, the separator can be hydrocyclone. Known hydrocyclones can be used. A hydrocyclone can comprise a cylindrical shaped feed part with tangential feed; an overflow part with vortex finder; and a conical part with an apex. The treated aqueous stream (40) can be fed into the hydrocyclone tangentially under a certain pressure, for example a pressure of about 1 to about 45 bars or about 1 to about 40 bars. This creates a centrifugal movement, pushing the heavier phase (potassium salts and/or ammonia salts) outward and downward alongside the wall of the conical part. The decreasing diameter in the conical part increases the speed and so enhances the separation. The concentrated solids are discharged through the apex as the potassium and/or ammonia salt stream (70). The vortex finder in the overflow part creates a fast rotating upward spiral movement of the fluid in the center of the conically shaped housing, and the fluid is discharged through the overflow outlet as a brine stream (60).

The recovered potassium and/or ammonia salt stream (70) comprises at least one of a solid potassium salt, or a solid ammonium salt as described herein in the context of the slurry.

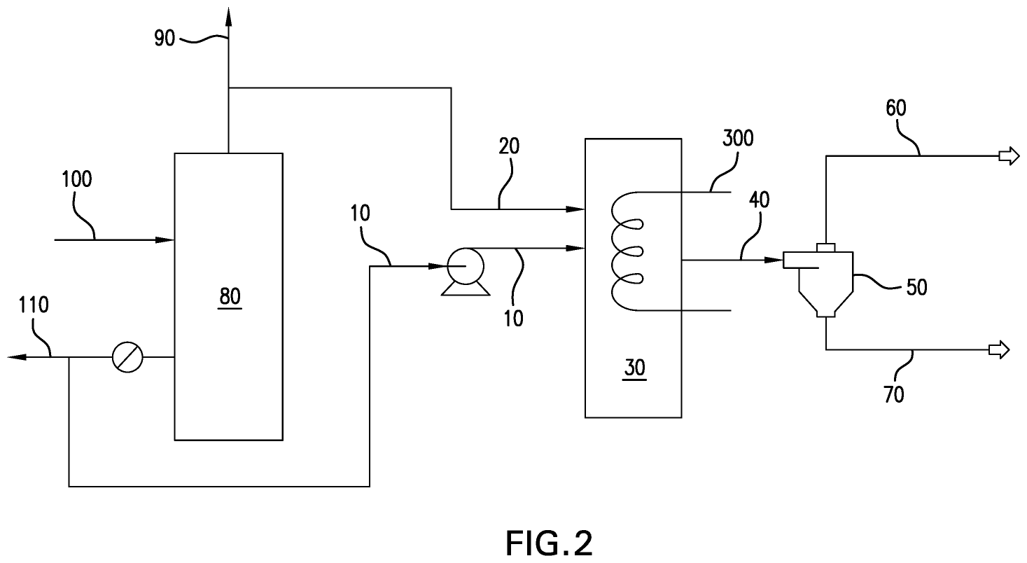

The carbon dioxide stream (20) for inducing the recovery of potassium and/or ammonia salts is readily available at an MSP plant. Referring to FIG. 2, the carbon dioxide stream (20) can be generated from a CO₂-containing solution (100) in a regenerator (80). The CO₂-containing solution (100) can comprise water, dissolved carbon dioxide, and ions such as potassium ions, ammonium ions, carbonate ions, and/or bicarbonate ions.

In the regenerator (80), the CO₂-containing solution (100) is subjected to a high temperature of about 110 to about 200° C. or about 160 to about 200° C. releasing a CO₂ gas stream (90) and generating a CO₂-depleted aqueous solution (110). The pressure within the regenerator (80) can be about 2 to about 20 bars or about 2 to about 40 bars. The regenerator (80) can have different zones, with each zone having a different operation temperature and/or a different pressure.

About 0.1 to about 1 vol % or about 0.1 to about 5 vol % of the carbon dioxide generated from the regenerator (80) can be introduced into the treatment unit (30) as the carbon dioxide stream (20). If needed, the carbon dioxide generated from the regenerator can be cooled down before it is introduced into the treatment unit (30).

About 0.1 to about 3 vol % of the CO₂-depleted aqueous solution (110) from the regenerator (80) is purged to avoid water accumulation in the plant. The purged aqueous stream or simply aqueous stream (10) can be introduced into the treatment unit (30) to recover potassium and/or ammonia salts.

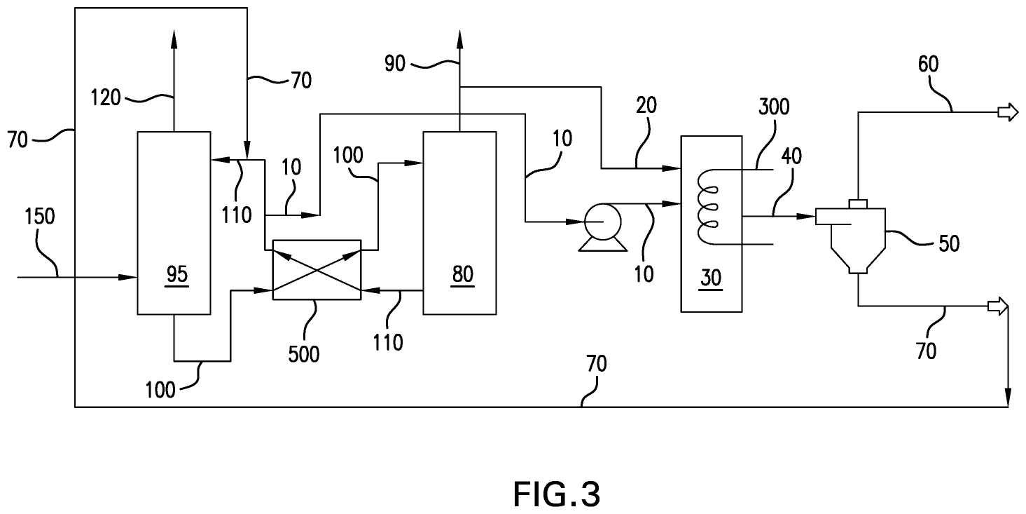

The process to recover potassium and ammonium salts as described herein can be integrated into a potential MSP layout. Referring to FIG. 3, the recovered potassium and/or ammonia salt stream (70) obtained from the separator (50) can be diluted with a CO₂-depleted aqueous solution (110) and then returned to an absorber (95) that generates a CO₂-depleted gas (120) from a CO₂-rich gas (150). Although not shown, it is appreciated that the process can use more than one absorber, and/or more than one regenerator. In addition, one absorber can have multiple zones/units with different absorption solutions, for example, absorption solutions with different concentrations of the sorbents, or absorption solutions having different temperatures.

Referring to FIG. 3, a process to capture CO₂ comprises contacting a CO₂-rich gas (150) with an absorption solution in an absorber (95) to generate a CO₂-containing solution (100) and a CO₂-depleted gas stream (120). The CO₂-containing solution (100) is introduced into a heat exchanger (500), then into a regenerator (80), where a CO₂ gas stream (90) and a CO₂-depleted aqueous solution (110) are produced. The CO₂-depleted aqueous solution (110) produced from the regenerator (80) is also introduced into the heat exchanger (500) where the CO₂-depleted aqueous solution (110) transfers heat to the CO₂-containing solution (100) before it enters the regenerator (80). About 0.1 to about 3 vol % of the CO₂-depleted aqueous solution (110) exiting the heat exchanger is introduced into a treatment unit (30) as an aqueous stream (10). About 0.1 to about 5 vol % of the CO₂ gas stream (90) generated from the regenerator (80) is introduced into the treatment unit (30) as a CO₂ stream (20). Then solid potassium and/or ammonia salts can be recovered in accordance with the process described herein. The recovered potassium and/or ammonia salt stream (70) can be returned to the absorber (95) after dilution in the CO₂-depleted aqueous solution (110) exiting the heat exchanger (500). Advantageously, the process can be a continuous process.

As the absorber can include one absorber unit or several interconnected absorber units, and each absorber unit can independently generate a CO₂-containing solution, in an aspect, the process of capturing CO₂ includes: contacting a CO₂-rich gas with an aqueous absorption solution in an absorber that includes one absorber unit or a system of several interconnected absorber units to generate one or more CO₂-containing solutions and a CO₂-depleted gas stream; providing one or more CO₂-depleted aqueous solutions from a regenerator; transferring heat from the one or more CO₂-depleted aqueous solutions to the one or more CO₂-containing solutions; introducing the one or more CO₂-containing solutions after heat exchange to the regenerator, the regenerator producing a CO₂ gas stream and the one or more CO₂-depleted aqueous solutions; introducing about 0.1 to about 3 vol % of any of the one or more CO₂-depleted aqueous solutions after heat exchange into a treatment unit as a set of aqueous streams; introducing about 0.1 to about 5 vol % of the CO₂ gas stream generated from the regenerator as a carbon dioxide stream into the treatment unit; and recovering solid potassium and/or ammonia salts in accordance with the process as described herein.

The CO₂-rich gas can include flue gas streams from power plants or other industrial CO₂ sources. The absorption solution can comprise water; ammonia, ammonium hydroxide, an ammonia salts such as ammonium carbonate, ammonium bicarbonate, or a combination thereof; and a potassium salt such as potassium carbonate and potassium bicarbonate. The total concentration of the inorganic salts in the absorber can be about 5 wt % to about 40 wt % or 30 wt % to 40 wt %, based on a total weight of the absorption solution. Absorber can operate at about 20 to about 40° C. and about 1 atm.

### EXAMPLE

An aqueous stream having a temperature of 41° C. and a pressure of 1 bar is treated with a carbon dioxide stream having a pressure of 15 bars in accordance with a process as shown in FIG. 1. The aqueous stream contains 85.8 mol % of H₂O, 3.1 mol % of dissolved NH₃, 6.1 mol % of potassium ions, 0.4 mol % of ammonium ions, 2.0 mol % carbonate ions, 0.4 mol % bicarbonate ions, and 2.1 mol % of carbamate ions (NH₂COO⁻). The results are shown in the table below.

| T slurry | K⁺ precipitated as | NH₃ precipitated as | W^{total}_{eq} |
|---|---|---|---|
| (° C.) | KHCO₃ | NH₄HCO₃ | (MJ/kmol K⁺) |
| 25 | 23% | 62% | 8.0 |
| 15 | 38% | 70% | 9.3 |
| 10 | 45% | 73% | 10.9 |

The process as disclosed herein can require less energy than an evaporation/vacuum crystallization process to recover potassium salts.

Set forth below are some aspects of the foregoing disclosure:

Aspect 1. A process comprising: introducing an aqueous stream comprising at least one of ammonium cations or potassium cations, and at least one of carbonate anions or bicarbonate anions into a treatment unit; introducing a carbon dioxide stream comprising CO₂ into the treatment unit; contacting the aqueous stream with the carbon dioxide stream to form a mixture; removing heat from the treatment unit to control a temperature of the mixture; forming a slurry from the mixture, the slurry comprising water and at least one of a solid potassium salt, or a solid ammonium salt; withdrawing the slurry from the treatment unit as a treated aqueous stream; and introducing the treated aqueous stream into a separator to generate a brine stream, and a recovered potassium and/or ammonia salt stream comprising at least one of the solid potassium salt or the solid ammonium salt.

Aspect 2. The process as in any prior aspect, wherein the process is a continuous process.

Aspect 3. The process as in any prior aspect, wherein the aqueous stream has a temperature of up to 60° C. before being introduced into the treatment unit.

Aspect 4. The process as in any prior aspect, wherein the mixture in the treatment unit has a temperature of about a freezing point of the mixture to about 30° C., for example about 2° C. to about 30° C.

Aspect 5. The process as in any prior aspect, wherein the carbon dioxide stream comprises greater than 80 vol % of CO₂.

Aspect 6. The process as in any prior aspect, wherein the carbon dioxide stream has a pressure of up to 40 bar.

Aspect 7. The process as in any prior aspect, further comprising generating the carbon dioxide stream from a CO₂-containing solution in a regenerator.

Aspect 8. The process as in any prior aspect, further comprising generating the aqueous stream from a CO₂-containing solution in a regenerator. The regenerator produces a CO₂-depleted aqueous solution, which is introduced into a heat exchanger to transfer heat to the CO₂-containing solution before it enters the regenerator, and wherein about 0.1 vol % to about 3 vol % of the CO₂-depleted aqueous stream exiting the heat exchanger is introduced into the treatment unit as the aqueous stream.

Aspect 9. The process as in any prior aspect, further comprising returning the recovered potassium and/or ammonia salt stream to an absorber after dilution in a CO₂-depleted aqueous solution.

Aspect 10. A process comprising: contacting a CO₂-rich gas with an aqueous absorption solution in an absorber to generate one or more CO₂-containing solutions and a CO₂-depleted gas stream; providing one or more CO₂-depleted aqueous solutions from a regenerator; transferring heat from the one or more CO₂-depleted aqueous solutions to the one or more CO₂-containing solutions; introducing the one or more CO₂-containing solutions after heat exchange to the regenerator, the regenerator producing a CO₂ gas stream and the one or more CO₂-depleted aqueous solutions; introducing about 0.1 to about 3 vol % of any of the one or more CO₂-depleted aqueous solutions after heat exchange into a treatment unit as a set of aqueous streams; introducing about 0.1 to about 5 vol % of the CO₂ gas stream generated from the regenerator as a carbon dioxide stream into the treatment unit; recovering solid potassium and/or ammonia salts according to a process as in any prior aspect. The process can further comprise returning the recovered potassium and/or ammonia salt stream to the absorber after dilution in the CO₂-depleted aqueous solution. The process can be a continuous process.

The use of the terms “a” and “an” and “the” and similar referents in the context of describing the invention (especially in the context of the following claims) are to be construed to cover both the singular and the plural, unless otherwise indicated herein or clearly contradicted by context. The terms “about”, “substantially” and “generally” are intended to include the degree of error associated with measurement of the particular quantity based upon the equipment available at the time of filing the application. For example, “about” and/or “substantially” and/or “generally” can include a range of ±8% a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A process of recovering solid potassium and/or ammonia salts comprising:
introducing an aqueous stream comprising at least one of ammonium cations or potassium cations, and at least one of carbonate anions or bicarbonate anions into a treatment unit;
introducing a carbon dioxide stream comprising CO₂ into the treatment unit;
contacting the aqueous stream with the carbon dioxide stream to form a mixture;
removing heat from the treatment unit to control a temperature of the mixture;
forming a slurry from the mixture, the slurry comprising water and at least one of a solid potassium salt, or a solid ammonium salt;
withdrawing the slurry from the treatment unit as a treated aqueous stream; and
introducing the treated aqueous stream into a separator to generate a brine stream, and a recovered potassium and/or ammonia salt stream comprising at least one of the solid potassium salt or the solid ammonium salt.

2. The process of claim 1, wherein the process is a continuous process.

3. The process of claim 1, wherein the aqueous stream has a temperature of up to 60° C. before being introduced into the treatment unit.

4. The process of claim 1, wherein the mixture in the treatment unit has a temperature of about a freezing point of the mixture to about 30° C.

5. The process of claim 1, wherein the mixture in the treatment unit has a temperature of about 2° C. to about 30° C.

6. The process of claim 1, wherein the carbon dioxide stream comprises greater than 80 vol % of CO₂.

7. The process of claim 1, wherein the carbon dioxide stream has a pressure of up to 40 bar.

8. The process of claim 1, further comprising generating the carbon dioxide stream from a CO₂-containing solution in a regenerator.

9. The process of claim 1, further comprising generating the aqueous stream from a CO₂-containing solution in a regenerator.

10. The process of claim 9, wherein the regenerator produces a CO₂-depleted aqueous solution, which is introduced into a heat exchanger to transfer heat to the CO₂-containing solution before the CO₂-containing solution enters the regenerator, and wherein about 0.1 vol % to about 3 vol % of the CO₂-depleted aqueous stream exiting the heat exchanger is introduced into the treatment unit as the aqueous stream.

11. The process of claim 1, further comprising returning the recovered potassium and/or ammonia salt stream to an absorber after dilution in a CO₂-depleted aqueous solution.

12. A process of capturing CO₂ comprising:
contacting a CO₂-rich gas with an aqueous absorption solution in an absorber to generate one or more CO₂-containing solutions and a CO₂-depleted gas stream;
providing one or more CO₂-depleted aqueous solutions from a regenerator;
transferring heat from the one or more CO₂-depleted aqueous solutions to the one or more CO₂-containing solutions;
introducing the one or more CO₂-containing solutions after heat exchange to the regenerator, the regenerator producing a CO₂ gas stream and the one or more CO₂-depleted aqueous solutions;
introducing about 0.1 to about 3 vol % of any of the one or more CO₂-depleted aqueous solutions after heat exchange into a treatment unit as a set of aqueous streams;
introducing about 0.1 to about 5 vol % of the CO₂ gas stream generated from the regenerator as a carbon dioxide stream into the treatment unit;
contacting the aqueous stream with the carbon dioxide stream in the treatment unit to form a mixture;
removing heat from the treatment unit to control a temperature of the mixture;
forming a slurry from the mixture, the slurry comprising water and at least one of a solid potassium salt, or a solid ammonium salt;
withdrawing the slurry from the treatment unit as a treated aqueous stream; and
introducing the treated aqueous stream into a separator to generate a brine stream, and a recovered potassium and/or ammonia salt stream comprising at least one of the solid potassium salt, or the solid ammonium salt.

13. The process of claim 12, further comprising returning the recovered potassium and/or ammonia salt stream to the absorber after dilution in the CO₂-depleted aqueous solution.

14. The process of claim 12, wherein the process is a continuous process.

15. The process of claim 12, wherein the aqueous stream has a temperature of about 25 to about 60° C. before being introduced into the treatment unit.

16. The process of claim 12, wherein the mixture in the treatment unit has a temperature of about a freezing point of the mixture to about 30° C.

17. The process of claim 12, wherein the mixture in the treatment unit has a temperature of about 2° C. to about 30° C.
